(19) United States
(12) Patent Application Publication
(10) Pub. No.: US 2022/0236020 A1
(43) Pub. Date: Jul. 28, 2022

(54) RADIATOR AND HYDROGEN GENERATOR WITH HEAT DISSIPATION FUNCTION

(71) Applicant: SHANGHAI ASCLEPIUS MEDITEC CO., LTD., Shanghai (CN)

(72) Inventor: Hsin-Yung LIN, Taoyuan City (TW)

(21) Appl. No.: 17/614,925

(22) PCT Filed: May 25, 2020
(86) PCT No.: PCT/CN2020/091978

§ 371 Date: Nov. 29, 2021

(30) Foreign Application Priority Data
May 28, 2019 (CN) 201910450356.8

(51) Int. Cl. F28F 1/40; F28D 21/00; C25B 1/04

(52) U.S. Cl. CPC F28F 1/40; F28D 2021/0028; C25B 1/04; F28D 21/00

(57) ABSTRACT

A radiator includes a base, a tubular structure, a plurality of fins and a spiral structure. The base has a water input port and a water output port. The tubular structure is coupled to the base and is further connected with the water input port and the water output port. A spiral structure is arranged inside the tubular structure, or the inner surface of the tubular structure has a delay structure formed by a plurality of bumps for improving heat dissipation efficiency of water. The tubular structure runs through the plurality of fins. In addition, the radiator of the present invention is applied to a hydrogen generator. The base of the radiator is directly and integrally formed with the upper cover of the water tank of the hydrogen generator, and the assembly can be completed only by coupling the base to the tube, thereby reducing the assembly process.

### BACKGROUND OF THE INVENTION

### 1. Field of the Invention

The present invention relates to a radiator, and more particularly relates to a radiator comprising a spiral structure or a delay structure to increase the length of the path for heat dissipation and a hydrogen generator using this radiator.

### 2. Description of the Prior Art

Most equipment generates a lot of redundant heat during operation. If the redundant heat cannot be quickly scattered, the heat will be accumulated in the equipment and the internal temperature of the equipment will be increased. Also, while the equipment works under a high temperature for a long time, not only the working efficiency of electronic components will be decreased, but also the operating life will be shortened because of the thermal damage to the equipment.

The hydrogen generators for generating the gas comprising hydrogen by electrolysis is easier to generate a large amount of heat during the electrolysis process. In order to avoid the thermal damage to the components of the hydrogen generator, a fan is usually used in the prior art to help the heat dissipation of the electrolysis cell. However, most of the heat in the electrolytic cell is accumulated in the electrolyzed water, and it is difficult to use the fan to dissipate heat for a large area.

In this regard, radiator columns are set in the hydrogen generator to make the electrolyzed water to pass through, so as to improve the heat dissipation efficiency by increasing the contact area between the electrolyzed water and the environment. However, in order to improve the heat dissipation efficiency, the length of the radiator column needs to be increased and then additional space to accommodate the radiator column is needed in the hydrogen generator, so that the size of the hydrogen generator cannot be reduced.

### SUMMARY OF THE INVENTION

Therefore, the present invention provides a radiator and a hydrogen generator with heat dissipation function to solve the problems of the prior art.

In one embodiment of the present invention, the radiator comprises a base, a column structure, a plurality of radiating sheets, and a spiral structure. The base comprises a water input port and a water output port. The column structure is coupled to the base, the water input port, and the water output port to receive and output a liquid. The column structure penetrates a plurality of radiating sheets. The spiral structure is disposed in the column structure.

Wherein, the base comprises a flow channel structure coupled to the column structure, thereby the column structure and the flow channel structure form a heat dissipation channel of the liquid.

Wherein, the flow channel structure comprises a water blocking board, and the column structure penetrates the water blocking board.

Wherein, the column structure comprises a straight area and a bending area, and the length of the spiral structure is approximately equal to the length of straight area of the column structure.

Wherein, the column structure comprises a plurality of the columns, the spiral structure comprises a plurality of the spiral columns corresponding to the plurality of columns, and each of the spiral columns is respectively disposed in the corresponding column.

Wherein, the base comprises a plurality of flow channels. The plurality of the columns comprise a first column, a second column, a third column and a fourth column, and the plurality of the flow channels comprise a first flow channel, a second flow channel and a third flow channel. The first column is coupled to the water input port and the first flow channel, the second column is coupled to the first flow channel and the second flow channel, the third column is coupled to the second flow channel and the third flow channel, and the fourth column is coupled to the third flow channel and the water output port.

Wherein, the base comprises a plurality of grooves, and the radiator further comprises a water blocking board disposed on the groove to form a plurality of flow channels. The column structure, the water blocking board, and the plurality of flow channels form a heat dissipation channel of the liquid.

In addition, the present invention provides anther radiator comprising a base, a column structure, and a plurality of radiating sheets. The base comprises a water input port and a water output port. The column structure is coupled to the base, and the column structure is coupled to the water input port and the water output port to receive and output a liquid. The column structure comprises a delay structure. Wherein, the column structure penetrates the plurality of radiating sheets.

The present invention also provides a hydrogen generator with heat dissipation function comprising a water tank, a radiator, and an electrolytic cell. The water tank comprises an accommodation space to accommodate the electrolyzed water, and the water tank comprises a tank body and an upper cover disposed on the tank body. The radiator is coupled to the water tank and comprises a column structure, a plurality of radiating sheets, and a spiral structure. The column structure is disposed out of the accommodation space. The column structure comprises the water tube input port and the water tube output port coupled to the accommodation space for receiving and outputting the electrolyzed water. Wherein, the column structure penetrates the plurality of radiating sheets and the spiral structure is disposed in the column structure. The electrolytic cell is disposed in the water tank and is coupled to the accommodation space for generating a gas comprising hydrogen by electrolyzing the electrolyzed water.

Wherein, the upper cover and the tank body are combined with each other to form the accommodation space to accommodate the electrolyzed water. The radiator further comprises a base. The base is disposed on the upper cover and comprises the water input port and the water output port coupled to the accommodation space. The column structure is coupled to the base. The water tube input port is coupled to the accommodation space through the water input port and the water tube output port is coupled to the accommodation space through the water output port to receive and output the electrolyzed water.

Wherein, the upper cover and the base are integrally formed.

Wherein, a side of the upper cover, which is near the accommodation space, comprises a fixing structure formed by a plurality of fixing units staggered with each other, and the water tank further comprises a cover plate to cover the fixing structure.

Wherein, the hydrogen generator with heat dissipation function further comprises a water pump comprising an actuator and a fan. The tank body further comprises a hollow structure to accommodate the actuator, a water supplement space to accommodate the fan, and a water input tube. The water supplement space is coupled to the accommodation space, and the water input tube is connected to the water supplement space and the water input port.

Wherein, the fan is configured to rotate in the accommodation space to drive the electrolyzed water in the accommodation space to enter the water input port through the water supplement space and the water input tube.

Compared to the present invention to prior art, the radiator of the present invention has the following advantages: 1. the radiator of the present invention uses the spiral structure and the delay structure to increase the path length in the column in the limited space, therefore the heat dissipation efficiency of the radiator is improved by increasing the contact area between the electrolyzed water and the external environment; 2. the radiator of the present invention does not need to increase extra column and extra installation space so as to downsize the hydrogen generator; 3. the radiator of the present invention forms a heat dissipation channel by combining the bottom and the column, so that the damaged column but not the entire radiator needs to be disassembled and replaced to reduce the maintain cost when the damage merely occurs on the column; and 4. the base of the radiator of the present invention is directly integrally formed with the upper cover of the water tank of the hydrogen generator, and then the assembly is completed by coupling the column to the base, thereby reducing the assembly process.

### BRIEF DESCRIPTION OF THE APPENDED DRAWINGS

FIG. 1 is a schematic diagram illustrating the radiator according to an embodiment of the present invention.

FIG. 2A is a structure explode diagram illustrating a partial enlargement diagram of radiator in FIG. 1.

FIG. 2B is a partial structure explode diagram illustrating the radiator according to another embodiment of the present invention.

FIG. 2C is an enlarged schematic diagram of a part of the base part in FIG. 2A.

FIG. 2D is an enlarged schematic diagram of the heat dissipation sheet in FIG. 2A.

FIG. 3 is a partial cross-section illustrating the section line A-A′ according to FIG. 1.

FIG. 4A is an inside partial schematic diagram illustrating the inside of the column structure of the radiator according to an embodiment of the present invention.

FIG. 4B is an inside partial schematic diagram illustrating the column structure of the radiator according to another embodiment of the present invention.

FIG. 5A is a structure explode diagram illustrating the radiator and hydrogen generator with heat dissipation function according to an embodiment of the present invention.

FIG. 5B is a structure explode diagram illustrating the radiator and hydrogen generator with heat dissipation function according to another embodiment of the present invention.

FIG. 5C is a partially enlarged schematic diagram of FIG. 5A.

FIG. 6A is a schematic diagram illustrating the water pump of the hydrogen generator with heat dissipation function according to an embodiment of the present invention.

FIG. 6B is a cross-section view along the section line B-B′ in FIG. 5B.

FIG. 6C is a schematic diagram illustrating the tank body and the water pump of the hydrogen generator with heat dissipation function according to an embodiment of the present invention.

FIG. 6D is a cross-sectional view along the section line C-C′ in FIG. 6C.

FIG. 6E is a partial structural diagram according to FIG. 6C.

FIG. 6F is a partial structural diagram of the tank body and the water pump of the hydrogen generator with heat dissipation function according to another embodiment of the present invention.

FIG. 7 is an explode diagram illustrating the radiator and hydrogen generator with heat dissipation function according to an embodiment of the upper cover of the present invention.

FIG. 8 is an explode diagram illustrating the radiator and hydrogen generator with heat dissipation function according to an embodiment of the electrolytic cell of the present invention.

FIG. 9 is a base view illustrating the radiator and hydrogen generator with heat dissipation function according to an embodiment of the electrolytic cell fix sheet of the present invention.

FIG. 10 is an inside schematic diagram illustrating the radiator and hydrogen generator with heat dissipation function according to an embodiment of the tank body and the water pump of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of the present specification, the terminologies “in an embodiment”, “in another embodiment”, or “in some embodiments” means that the specific feature, structure, material or characteristic of the present embodiment is involved in at least one embodiment of the present invention. In the description of the present specification, the schematic representation of the mentioned terminologies does not necessarily refer to the same embodiment. Furthermore, the described specific feature, structure, material or characteristic can be involved in any one or more embodiments in a proper way.

In the embodiments of the present specification, the terminology “or” includes the combination of part of listed components, and the combination of all the listed components. For example, the described “A or B” includes only A, only B, and both A and B. Moreover, the terminologies “a” and “the” before the element or component of the present invention do not limit the number of element or component. Therefore, the terminologies “a” and “the” should be read as including one or at least one. Besides, the singular form of element or component also includes the plural form, unless the number clearly refers to the singular form.

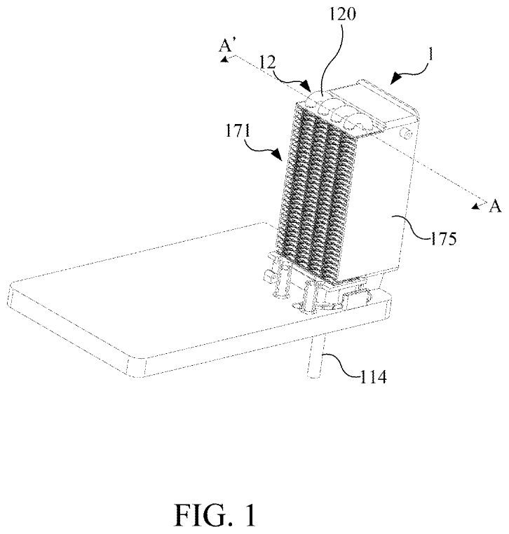

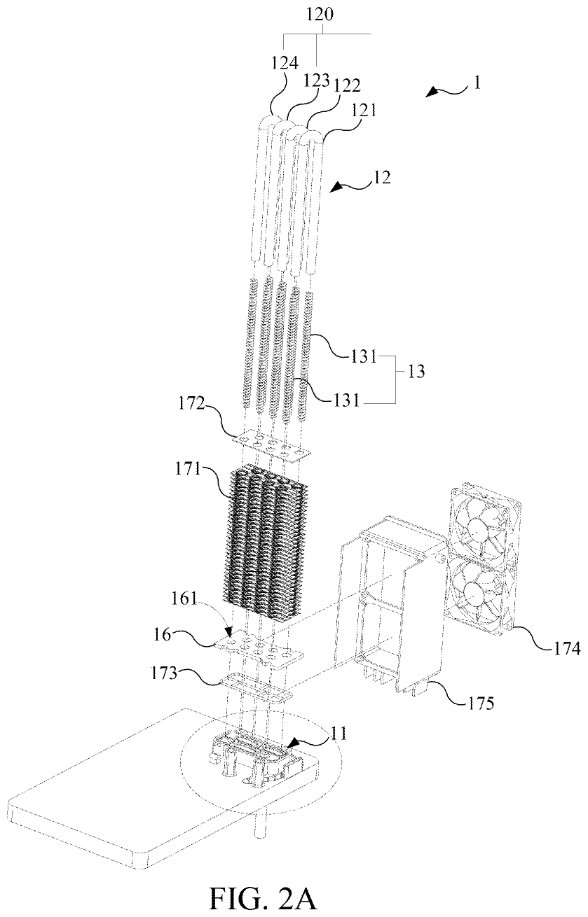

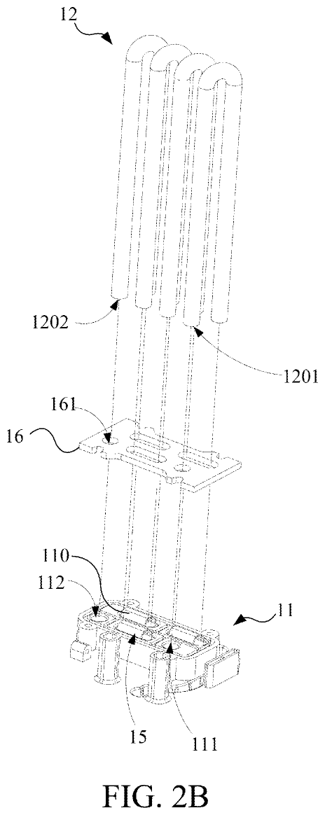

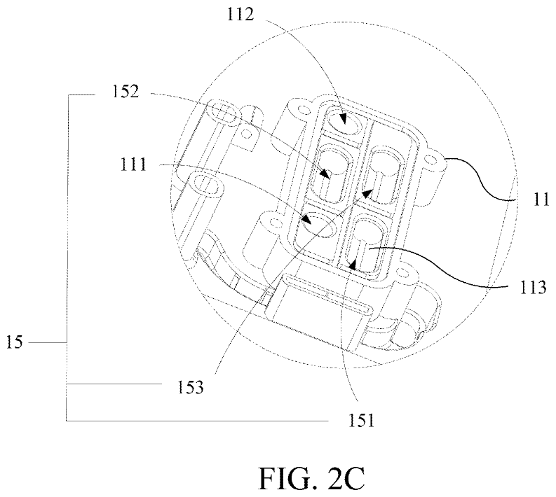

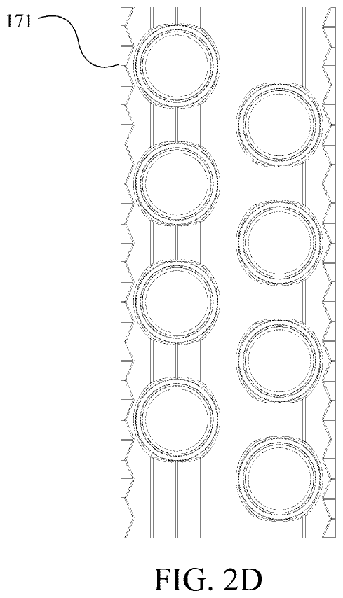

Please refer to FIG. 1, FIG. 2A, FIG. 2B, FIG. 2C and FIG. 2D. FIG. 1 is a schematic diagram illustrating the radiator according to an embodiment of the present invention. FIG. 2A and FIG. 2C are a structure explode diagram and an enlarged schematic diagram according to FIG. 1. FIG. 2B is a partial structure explode diagram illustrating the radiator according to another embodiment of the present invention. As shown in FIG. 1, FIG. 2A, FIG. 2B, FIG. 2C and FIG. 2D, in one embodiment, the radiator of this present invention comprises the base 11 and column structure 12. The base 11 comprises the water output port 111 and the water input port 112. The column structure 12 is coupled to the base 11, the water output port 111, and the water input port 112, and is configured to receive the liquid. The spiral structure 13 is disposed in the column structure to increase the length of path. Wherein, the spiral direction of the spiral structure 13 is disposed along the direction of the cylinder center of the spiral structure 13.

As shown in FIG. 2B, the base 11 comprises the flow channel structure 110 coupled to the column structure 12; therefore, the column structure 12 and flow channel structure 110 form the cooling flow channel of liquid (the figure is not shown). In one embodiment, the cooling flow channel 110 comprises the water blocking board 16, and the column structure 12 penetrates the water blocking board 16.

In one embodiment, the column structure 12 comprises the plurality columns 120. The spiral structure 13 comprises the plurality of the spiral structures 131 to correspond the plurality of columns 120. Each of the spiral columns 131 is respectively disposed in the corresponding column 120. In another embodiment, the base 11 comprises the plurality of the unconnected flow channels 15. The plurality of columns 120 can be respectively coupled to the water output port 111, one of the flow channels 15, two adjacent flow channels 15, one of the flow passages 15, and the input port 112. The water output port 111 is coupled to the water inlet 112 through the plurality of columns 120 and the plurality of flow channels 15. Furthermore, the plurality of columns 120 comprises the first column 121, the second column 122, the third column 123, and the fourth column 124, and the plurality of flow channels 15 comprises the first flow channel 151, the second flow channel 152, and the third channel 153. The first column 121 is coupled to the water output port 111 and the first flow passage 151. The second column 122 is coupled to the first flow channel 151 and the second flow channel 152. The third column 123 is coupled to the second flow channel 152 and the third flow channel 153. The fourth column 124 is coupled to the third flow channel 153 and the water input port 112.

Wherein, the flow channel structure 110 and the base 11 can be integrally formed, or can also be assembly structured. As shown in the partial structure explode diagram in FIG. 2, the base 11 comprises the plurality of grooves. The radiator 1 further comprises the water blocking board 16 and is disposed on the groove to form the plurality of flow channels 15. The water blocking board 16 comprises the plurality of holes 161 by respectively forming the entrance and the exit of each flow channel 15. The water blocking board 16 also comprises the holes 161 by respectively being coupled to the water output port 111 and the water input port. The plurality of columns 120 can respectively fit into the plurality of holes 161 by using the water blocking board 16, thereby forming the cooling flow channel from the water output port 111 to the water input port 112 (the figure is not shown). In another embodiment, the base 11 and the column 12 can be integrally formed.

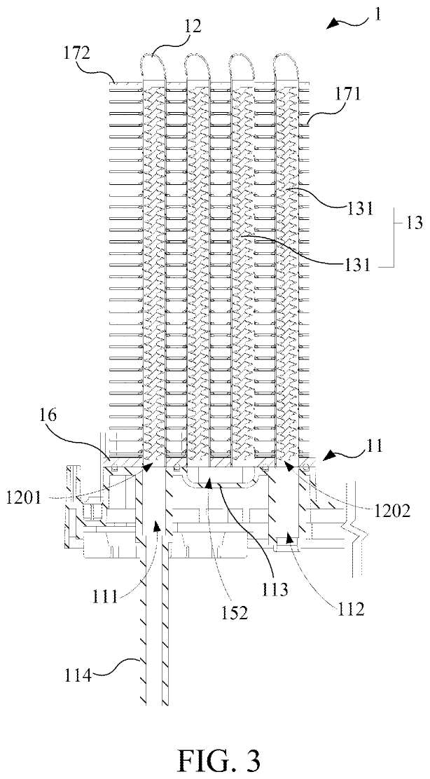

Please refer to FIG. 3. FIG. 3 is a partial cross-section illustrating the section line A-A′ according to FIG. 1. As shown in FIG. 3, FIG. 3 is a cross-section according to line A-A′ from the water output port 111, second flow channel 152 and water input port 112. As shown in FIG. 3, the water output port 111 of the base 11, the forming groove 13 of second flow channel, and the water input port 112 are not connected. In practice, the radiator 1 can use the water blocking board 16 to assemble the column structure 120 and the base 11. Remove the column 120 from the water blocking board 16 and separate the column 120 and base when the column 120 is damaged and is needed to clean. Therefore, the procedure of the assembly and disassembly can be simple. In addition, as shown in FIG. 3, in practical applications, the water output duct 114 can be coupled below the water output port 111 to output the liquid after heat dissipation.

Please refer to FIG. 2A, FIG. 2B, FIG. 2C and FIG. 2D again. As shown in the figures, the radiator 1 of this present invention further comprises the heat dissipation sheet 171, the fixed sheet 172, and the gasket 173. As shown in FIG. 2, in the enlarged view of the heat dissipation sheet, the heat dissipation sheet 171 and the fixed sheet 172 comprise the plurality of holes and are corresponding to the plurality of holes 161 of the water blocking board 16, thereby providing the column 120 through into the hole. In other embodiment, the heat dissipation sheet 171 and the fixed sheet 172 can be the two-piece combined structure. In another embodiment, the plurality of holes on the heat dissipation sheet 171 and the fixed sheet 172 are disposed according to the shape of the column 120. Alternatively, the heat dissipation sheet 171 is disposed surrounding the column 120 without comprising holes. The radiator 1 can comprise the plurality of heat dissipation sheets 171 and the heat dissipation sheet is disposed at a fixed interval. The heat dissipation sheet 171 can be a three-dimensional wave-like structure, thereby increasing the heat dissipation surface area per unit volume. The fixed sheet 172 can be arranged at one end of the column 120 and far away from the base 11, that is in front of the bend of U-shaped column 120, thereby fixing the position of each column 120. The gasket 173 is disposed between the base 11 and the water blocking board 16. The gasket 173 can be used to separate the water output port 111, the plurality of grooves 113, and the water input port 112. Therefore, the base 11 and the water blocking board 16 are combined to form the first flow channel 151, the second flow channel 152, and the third flow channel 153 which are not connected to each other through the base 11 and are not connected to the water output port 111 and the water input port 112, to ensure the path length from the water input port 112 to the water output port 111.

The radiator 1 can further comprises the fan 174 disposed on one side of the radiator. The fan is used to pass the cold air of the external environment into the radiator 1 or output the hot air inside the radiator 1. In addition, the radiator 1 can further comprise the radiator protective shell 175 disposed on the peripheral of the column structure 12 and the heat dissipation sheet 171 to protect the column structure 12 and the heat dissipation sheet 171 against external crash. Besides, the radiator protective shell 175 is also used to fix the relative position of the fan 174 and the column structure 12.

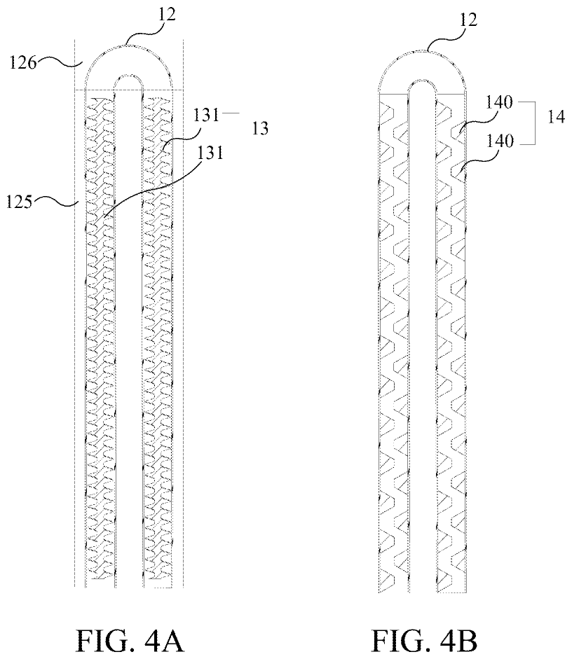

Please refer to FIG. 4A and FIG. 4B. FIG. 4A is an inside partial schematic diagram illustrating the inside of the column structure of the radiator according to an embodiment of the present invention. FIG. 4B is an inside partial schematic diagram illustrating the column structure 120 of the radiator according to another embodiment of the present invention. The radiator 1 not only can dispose the spiral structure 13 (as shown in FIG. 4A) in the column structure 12 to extend the length of the internal path of the column structure 12 but also can be the forms like the column structure 12 as shown in FIG. 4B. The surface of column structure 12 of FIG. 4B comprises the delay structure 14 formed by the plurality of 140, thereby the path length in the column structure 12 is increased. In addition, the protrusion 140 can form the internal spiral structure on the inner surface of the column structure 12. In another embodiment, the delay structure 14 not only can be the protrusion 140 on the surface but also can be other structures that can delay the flow rate of the liquid, such as a mesh structure. In other words, the path length can be extended by the column structure 12 itself or additionally added the spiral structure 13. Furthermore, the column structure 12 can use the spiral structure 13 and the delay structure 14 at the same time. In addition, the column structure 12 comprises the straight area 125 and the bending area 126.The length of the spiral structure 13 is approximately equal to the length of the straight area 125 in the column structure 12.

In practice, the shape of the column structure 12 comprises one of the U-shape and the spiral shape. The spiral structure 13 in the U-shaped column structure 12 can comprise two I-shaped spiral columns 131, respectively arranged on both sides of the U-shaped column structure 12 (as shown in FIG. 4A) The U-shaped spiral structure 13 is disposed in the U-shaped column structure 12. The spiral direction of the spiral column structure 12 can be perpendicular to the opening direction at both ends of the spiral column structure 12. The spiral structure 13 in the spiral column structure 12 matches the inner diameter of the spiral column structure 12.

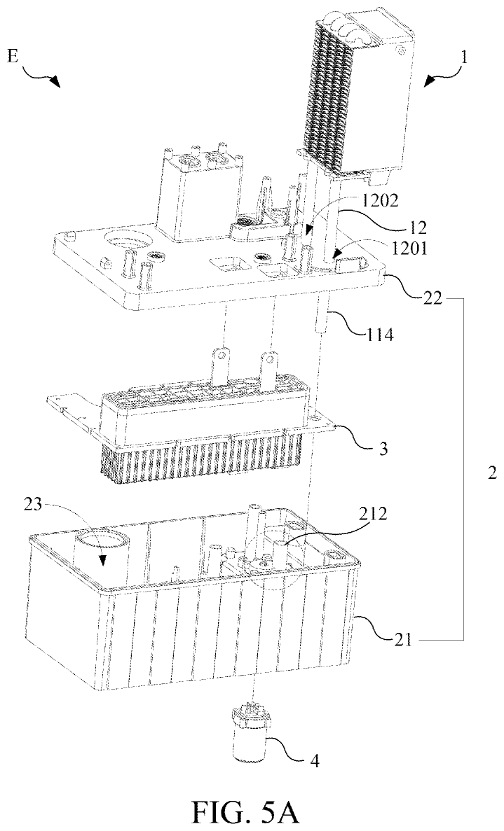

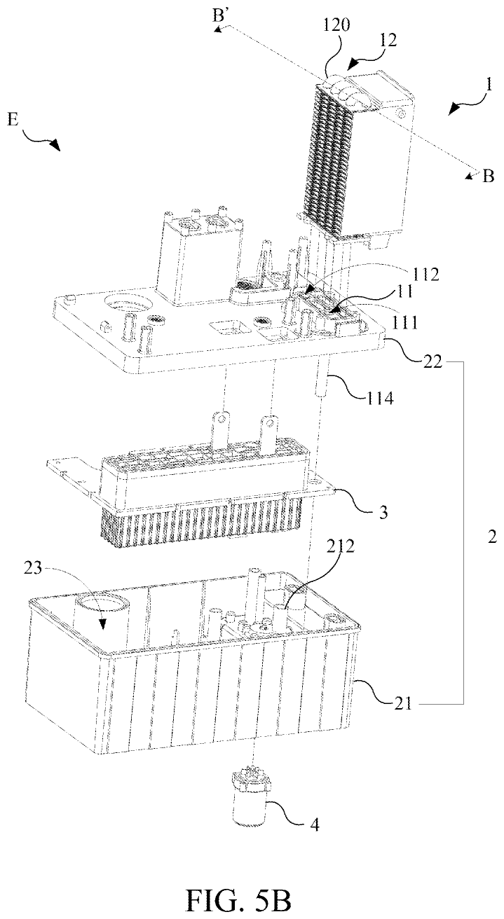

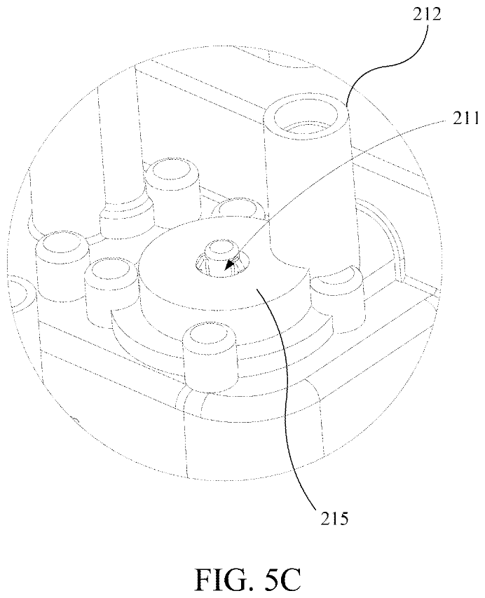

Please refer to FIG. 5A and FIG. 5C. FIG. 5A is a structure explode diagram illustrating the radiator and hydrogen generator E with heat dissipation function according to an embodiment of the present invention. As shown in FIG. 5A, in one embodiment, the radiator 1 of the present invention can be disposed in the hydrogen generator E with the heat dissipation function to assist heat dissipation. The hydrogen generator E with the heat dissipation function comprises the water tank 2, the radiator 1, and the electrolytic cell 3. The water tank 2 comprises the accommodation space to accommodate the electrolyzed water. The radiator 1 is coupled to the water tank 2. The radiator 1 comprises the column structure 12 disposed out of the accommodation space 23. The column structure 12 comprises the water tube input port 1202 and the water tube output port 1201 to connect the accommodation space 23. The column structure 12, through the water tube input port 1202, receives the electrolyzed water and output the electrolyzed water after heat dissipation by the water tube output port 1201. The column structure 12 comprises the spiral structure 13 to increase the path length of the column structure 12. The electrolytic cell 3 connects the accommodation space 23 for electrolyzing the electrolyzed water to produce the hydrogen comprising gas. In a better embodiment, the water tank 2 comprises the tank body 21 and the upper cover 22. The upper cover 22 is disposed on the tank body 21. The upper cover 22 is combined with the tank body 21 to form the accommodation space 23 for accommodating the electrolyzed water. The column structure 12 is not only coupled with the accommodating space 23through the upper cover 22 (as shown in FIG. 5A), but also is coupled with the tank body 21 to connect with the accommodating space 23 through the tank body 21, and it is not limited to this.

Please refer to FIG. 5B. FIG. 5B is a structure explode diagram illustrating the radiator and hydrogen generator with heat dissipation function according to another embodiment of the present invention. As shown in FIG. 5B, most components of the embodiment in FIG. 5B are the same as the ones of the embodiment in FIG. 5A. However, the difference is that the radiator 1 further comprises a base 11, and the base 11 is inserted into the upper cover 22 or is integrally formed with the upper cover 22. The base 11 comprises the accommodation space to connect with the water input port 111 and the water output port 112. The column structure 12 is coupled to the base 11, the water input tube port 1202 and the accommodation space 23 through the water input port 112; and the water input tube port 1202 is coupled to the accommodation space 23 through the water output port 111. The water output duct 114 is connected the water output port 111 and the accommodation space 23. The electrolyzed water is outputted from the water output port 111 to the water output duct 114. Therefore, the electrolyzed water after heat dissipation is injected into the accommodation space 23. Because of the structure and function of the radiator 1 are the same as the aforementioned radiator 1, which is not repeated herein.

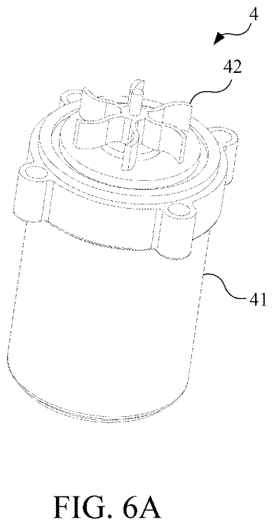

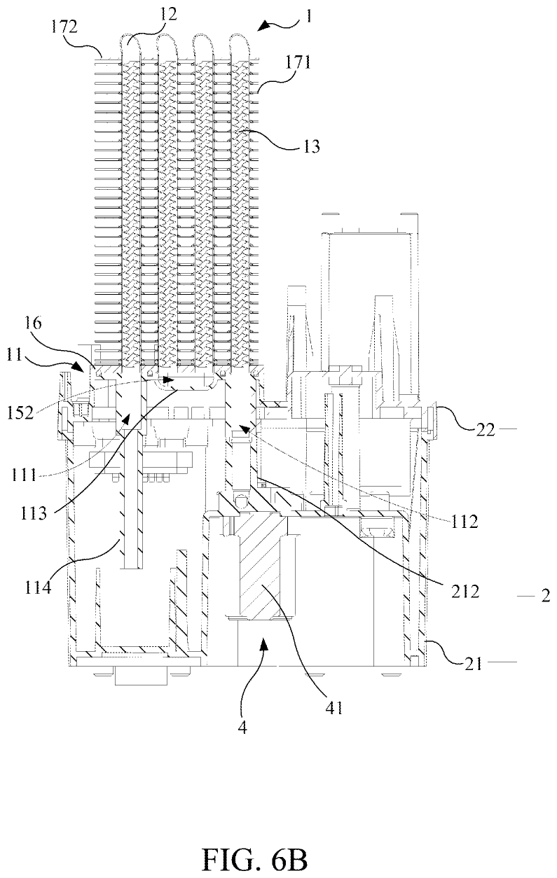

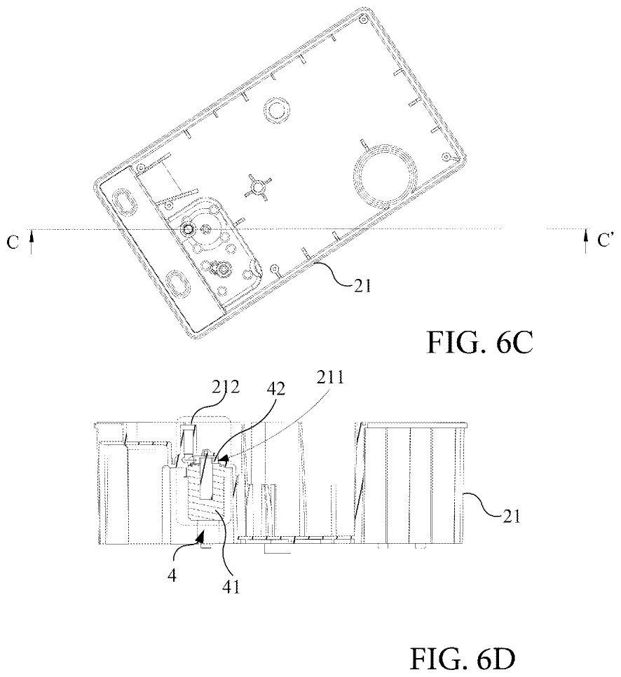

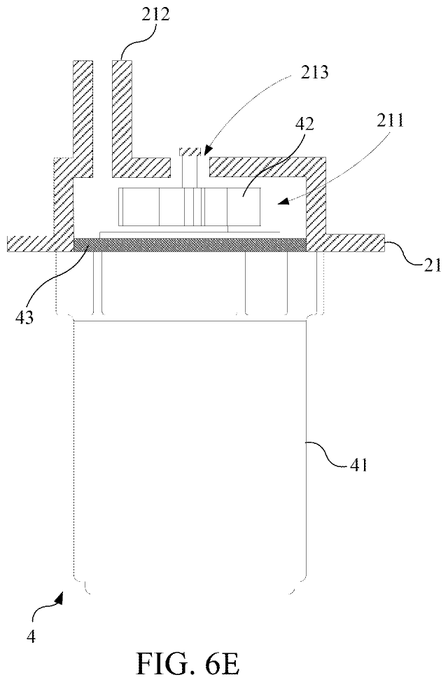

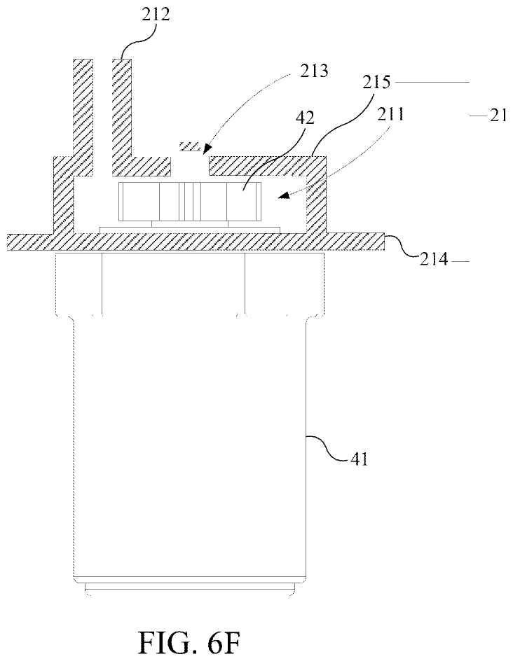

Please refer to FIG. 6A to FIG. 6F. FIG. 6A is a schematic diagram illustrating the water pump 4 of the hydrogen generator E with heat dissipation function according to an embodiment of the present invention. FIG. 6B is a cross-section view along the section line B-B′ in FIG. 5B.. FIG. 6C and FIG. 6D are a schematic diagram illustrating the tank body 21 and the water pump 4 of the hydrogen generator E with heat dissipation function according to an embodiment of the present invention and a cross-sectional view along the section line C-C′. FIG. 6E is a partial structural diagram according to FIG. 6C. FIG. 6F is a partial structural diagram of the tank body and the water pump 4 of the hydrogen generator with heat dissipation function according to another embodiment of the present invention. In an embodiment, the hydrogen generator E with heat dissipation function comprises a water pump 4. As shown in FIG. 6A, the water pump 4 comprises an actuator 41 and a fan 42. As shown in FIG. 6B to FIG. 6D, the tank body 21 further comprises the recessed structure, the water supplement space 211, and the water input tube 212. The recessed structure can accommodate the actuator 41, the water supplement space, and the fan 42. Wherein, the water supplement space 211 is connected to the accommodation space 23. The water input tube 212 is connected to the water supplement space 211 and the water input port 112. Therefore, the fan 42 can rotate in the accommodation space 23, so as to let the electrolyze water enter the water input port 112 through the accommodation space 23 and water input tube 212.

Furthermore, as shown in FIG. 6B to FIG. 6D, in one embodiment, the water tank 2 comprises the recessed structure disposed on the surface inward, thereby forming the water supplement space 211 for accommodating the fan 42 of the water pump 4. When the water tank 2 is combined with the water pump 4, the actuator 4 is coupled to the fan 42 of water supplement space 211 and disposed outside the accommodation space 23. Therefore, the actuator 41 can avoid the damage by water injection. Also, the heat generated by the rotation of the actuator 41 and stored in the electrolyzed water of the accommodation space 23 can be reduced.

More specifically, the structure at the dashed box in FIG. 6C is shown in FIG. 6E. The water pump further comprises the gasket 43 disposed between the actuator 41 and the fan 42. The recessed structure of the water body 21 can combine with the water pump 4, so as to make the fan 42 be accommodated in the water supplement space 211 formed by the combination of the recessed structure of the water body 21 and the gasket 43 of the water pump 4. The accommodation space 23 of the water body 21 is above the fan 42 coupled with the through hole 213. When the water pump 4 is rotated. The actuator 41 drives the fan 42, so that the electrolyzed water in the accommodation space 23 is guided by the fan 42 from the through hole 213 into the water supply space 211, and then from the water supply space 211 to the water input port 112 through the water input tube 212.

In another embodiment, please refer to the enlargement diagram FIG. 5C of FIG. 5A and FIG. 6F. The water pump 4 can be the separated structure in which the actuator 41 and the fan 42 are separated. The tank body 21 of the water tank 2 further comprises the water input tube 212 coupled to the water supplement space 211. The tank body 21 further comprises the casing structure 214 and the first structure 215. The first structure 215 is combined with the casing structure 214 to form the water supplement space for accommodating the fan 42. The first structure 215, the casing structure 214, and the water input tube 212 can be the combined structure to connect the accommodation space 23, the water supplement space 211, and the water input port 112. In another embodiment, the first structure 215, the casing structure 214, and the water input tube 212 can be integrally formed. The actuator 41 is disposed outside of the casing structure and is corresponded to the fan 42. The actuator 41 can use the magnetic coupling to drive the fan 42 to rotate. Therefore, the electrolyzed water in the accommodation space 23 is guided into the water input port 112.

Furthermore, the tank body 21 of the water tank 2 further comprises the water input tube 212 to connect with the water supplement space 211. Wherein, the water supplement space 211 is connected with accommodation space 23. The water input tube 212 is connected with the water input port 112. When the fan 42 rotates in the water input tube 211, the electrolyzed water in the accommodation space 23 is drived by the fan 42 into the water supplement space 211. The fan 42 inputs the electrolyzed water from the water supplement space 211 to the water input tube 212 and enters into the radiator 1 through the water input port 112.

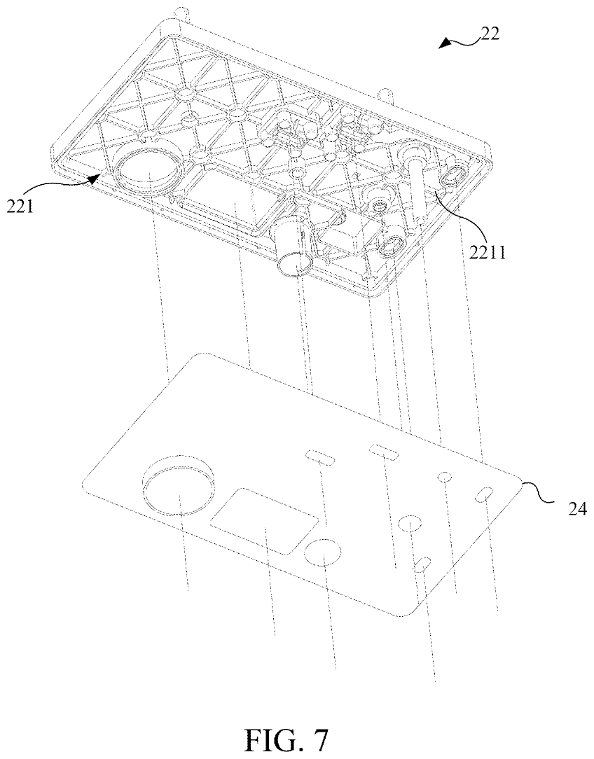

Please refer to FIG. 7. FIG. 7 is an explode diagram illustrating the radiator and hydrogen generator E with heat dissipation function according to an embodiment of the upper cover of the present invention. As shown in FIG. 7, in one embodiment, the side of the adjacent accommodation space 23 of the upper cover 22 of the water tank 2 comprises the plurality of fixing units 2211 to staggeredly form the fixing structure 221. The water tank 2 comprises the cover plat and the fixing structure 221. This fixing structure 221 is used to strengthen the structure of the upper cover 22 to support the radiator 1 and is made of the corrugated paper. In practical applications, when the electrolytic cell 3 electrolyzes the electrolyzed water in the water tank 2 to generate the hydrogen comprising gas in the accommodation space 23, the fixing structure 221 of the upper cover 22 thickens the volume of the upper cover 22. Although the part of the accommodation space 23 is reduced, the time of the hydrogen comprising gas in the accommodation space 23 is shortened and the amount of gas is reduced in the accommodation space 23 due to the space constraint. The cover plate 24 is used to reduce the hydrogen comprising gas remaining in the staggered fixing unit 2211. Wherein, the above-mentioned electrolytic cell 3 can be disposed in the accommodation space 23 directly. Also, the additional tube can be added to connect with the accommodation space 23 to output the electrolyzed water to the electrolytic cell 3 and to input the hydrogen comprising gas and the high-temperature electrolyzed water into the accommodation space 23, which is not limited to this.

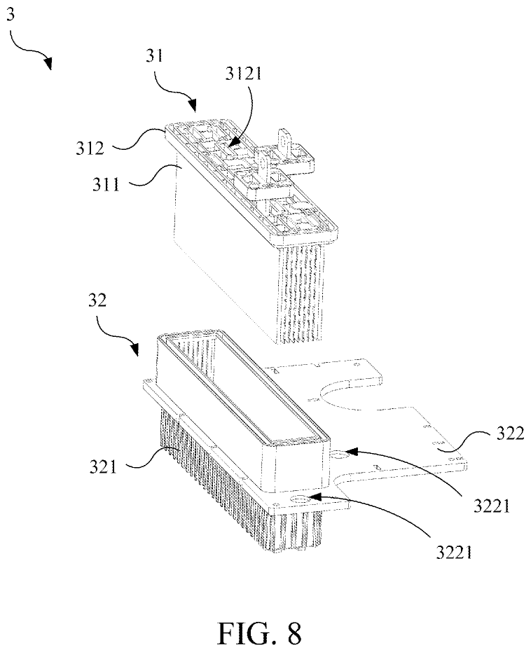

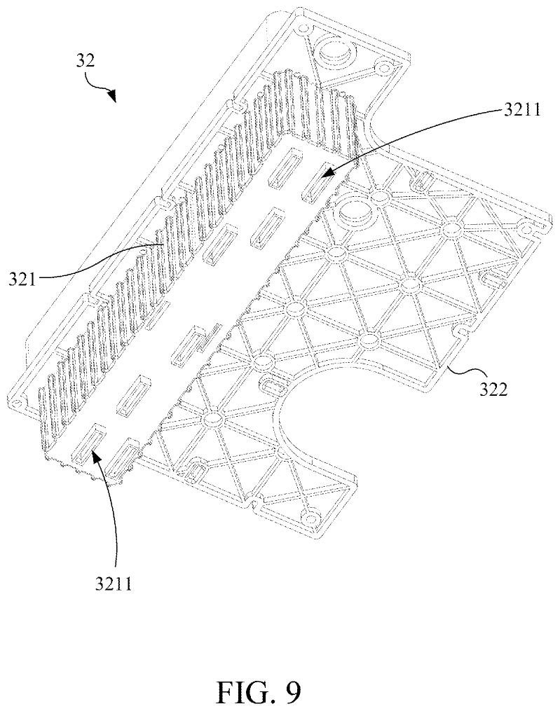

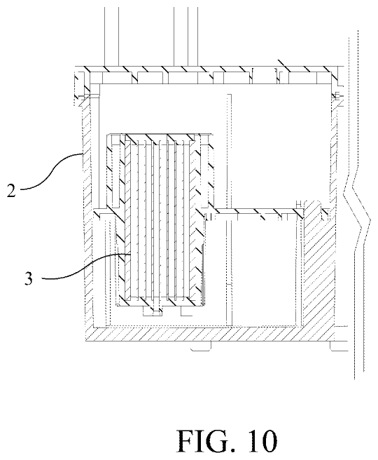

Please refer to FIG. 8 to FIG. 10. FIG. 8 is an explode diagram illustrating the radiator and hydrogen generator E with heat dissipation function according to an embodiment of the electrolytic cell of the present invention. FIG. 9 is a base view illustrating the radiator and hydrogen generator with heat dissipation function according to an embodiment of the electrolytic cell fix sheet 32 of the present invention. FIG. 10 is an inside schematic diagram illustrating the radiator and hydrogen generator with heat dissipation function according to an embodiment of the tank body 21 and the water pump 4 of the present invention. As shown in FIG. 8, in one embodiment, the electrolytic cell 3 comprises the electrode element 31 and the electrolytic cell fix sheet 32. The electrode element 31 can be disposed in the electrolytic cell body 321 of the electrolytic cell fixing plate 32. The electrode element 31 comprises the plurality of electrode sheet 311 and is connected to each electrode sheet 311 of the base plate 31. The base plate 312 is disposed on the upper surface of each electrode sheet 311. Therefore, the plurality of the electrode plates 311 can be respectively disposed. The electrode element 31 can form the plurality of the electrode flows when it is accommodated in the electrolytic cell body 321. As shown in FIG. 8 to FIG. 10, in another embodiment, the electrolytic cell fixing sheet 32 comprises the electrolytic cell body 321 and a separating sheet 322. The separating sheet 322 can be used to fix the electrolytic cell 3 in the water tank 2 and divide the water tank 2 into upper and lower layers. Therefore, the electrolyzed water is mainly disposed in the lower layer, and the hydrogen comprising gas is mainly disposed in the upper layer produced by electrolysis water. In order to keep the upper and lower layers in circulation. The separating sheet 322 comprises the plurality of water circulation holes 3221 to connect the upper layer and the lower layer. As shown in FIG. 9, the bottom side of the electrolytic cell body 321 comprises the plurality of water circulation holes 3211, so that the electrolyzed water can flow into each electrode channel through the water circulation hole 3211, and each electrode sheet 311 can be electrolyzed to generate the hydrogen comprising gas. In addition, the base plate 312 comprises the plurality of gas circulation holes 3121, so that the hydrogen comprising gas which is generated by electrolysis from the gas circulation hole 3121 flows to the water tank 2. The electrolytic cell fix sheet 32 can be integrally formed. In addition, it can be understood that those skilled in the art can design the shape of the separating sheet 322 according to requirements, and it is configured to provide the space for other components.

Please refer to FIG. 5A and FIG. 6B. The water input tube 212 is shorter than the water output duct 114. The water output duct 114 is disposed in lower layer of the water tank 2. Therefore, when the radiator 1 is worked, the radiator inputs the electrolyzed water which dissipates heat into the lower layer through the water output duct 114, and the radiator 1 receives the electrolyzed water from the upper layer. Therefore, the temperature of the electrolyzed water is reduced by circulating in the water tank 2.

Compared to the prior art, the radiator of the present invention has the following advantages: 1. The radiator of the present invention uses the spiral structure and the delay structure to increase the path length in the column structure with limited space; therefore, the heat dissipation efficiency of the radiator is improved by increasing the contact area between the electrolyzed water and the external environment. 2. The radiator of the present invention does not increase extra columns and extra installation space, so that the hydrogen generator can be downsized. 3. The radiator of the present invention combines the bottom and the column to form a heat dissipation channel; therefore, only the damaged column needs to be disassembled and replaced when the column get damaged. Since there is no need to replace the entire radiator, the subsequent maintenance costs can be reduced. 4. The base of the radiator of the present invention is directly and integrally formed with the upper cover of the water tank of the hydrogen generator, and the assembly can be completed only by coupling the column to the base, thereby reducing the assembly process.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A radiator, comprising:
a base comprising a water input port and a water output port;
a column structure coupled to the base and coupled to the water input port and the water output port, the column structure being configured to receive and output a liquid;
a plurality of radiating sheets, wherein the column structure penetrates the plurality of radiating sheets; and
a spiral structure disposed in the column structure.

2. The radiator of claim 1, wherein the base comprises a flow channel structure coupled to the column structure, the column structure and the flow channel structure form a heat dissipation channel of the liquid.

3. The radiator of claim 2, wherein the flow channel structure comprises a water blocking board, and the column structure penetrates the water blocking board.

4. The radiator of claim 1, wherein the column structure comprises a straight area and a bending area, the length of the spiral structure is approximately equal to the length of straight area of the column structure.

5. The radiator of claim 1, wherein the column structure comprises a plurality of the columns, and the spiral structure comprises a plurality of the spiral columns corresponding to the plurality of columns, each of the spiral columns is separately disposed in the corresponding column.

6. The radiator of claim 5, wherein the base comprises a plurality of flow channels, the plurality of the column comprises a first column, a second column, a third column and a fourth column, and the plurality of the flow channel comprising a first flow channel, a second flow channel and a third flow channel, the first column is coupled to the water input port and the first flow channel, the second column is coupled to the first flow channel and the second flow channel, the third column is coupled to the second flow channel and the third flow channel, and the fourth column is coupled to the third flow channel and the water output port.

7. The radiator of claim 1, wherein the base comprises a plurality of grooves, the radiator further comprises a water blocking board disposed on the grooves to form a plurality of flow channels, the column structure, the water blocking board and the plurality of flow channels form a heat dissipation channel of the liquid.

8. A radiator, comprising:
a base comprising a water input port and a water output port;
a column structure coupled to the base and coupled to the water input port and the water output port, the column structure being configured to receive and output a liquid, and the column structure comprising a delay structure; and
a plurality of radiating sheets, wherein the column structure penetrates the plurality of radiating sheets.

9. A hydrogen generator with heat dissipation function, comprising:
a water tank comprising an accommodation space to accommodate electrolyzed water, the water tank comprising a tank body and an upper cover disposed on the tank body; and
a radiator coupled to the water tank, comprising:
a column structure disposed out of the accommodation space, the column structure comprising a water tube input port and a water
tube output port coupled to the accommodation space for receiving and outputting the electrolyzed water;
a plurality of radiating sheets, wherein the column structure penetrates the plurality of radiating sheets; and
a spiral structure disposed in the column structure; and
an electrolytic cell disposed in the water tank and coupled to the accommodation space, the electrolytic cell being configured to generate a gas comprising hydrogen by electrolyzing the electrolyzed water.

10. The hydrogen generator with heat dissipation function of claim 9, wherein the upper cover and the tank body are combined with each other to form the accommodation space to accommodate the electrolyzed water, the radiator further comprises a base, the base is disposed on the upper cover and comprises the water input port and the water output port coupled to the accommodation space, the column structure is coupled to the base, the water tube input port is coupled to the accommodation space through the water input port, and the water tube output port is coupled to the accommodation space through the water output port to receive and output the electrolyzed water.

11. The hydrogen generator with heat dissipation function of claim 9, wherein the upper cover and the base are integrally formed.

12. The hydrogen generator with heat dissipation function of claim 9, wherein a side of the upper cover, which is near the accommodation space, comprising a fixing structure formed by a plurality of fixing units staggered with each other, and the water tank further comprises a cover plate to cover the fixing structure.

13. The hydrogen generator with heat dissipation function of claim 9, further comprising a water pump, the water pump comprising an actuator and a fan, wherein the tank body further comprises a hollow structure to accommodate the actuator, a water supplement space to accommodate the fan, and a water input tube, the water supplement space is coupled to the accommodation space, the water input tube connects the water supplement space and the water input port.

14. The hydrogen generator with heat dissipation function of claim 13, wherein the fan is configured to rotate in the accommodation space to drive the electrolyzed water in the accommodation space to enter the water input port through the water supplement space and the water input tube.
